(19) United States
(12) Patent Application Publication
(10) Pub. No.: US 2010/0091421 A1
(43) Pub. Date: Apr. 15, 2010

(54) INRUSH CURRENT PREVENTING CIRCUIT

(75) Inventor: CHIEH-HSUAN LEE, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/274,334

(22) Filed: Nov. 19, 2008

(30) Foreign Application Priority Data
Oct. 10, 2008 (CN) 200810304889.7

(51) Int. Cl. H02H 5/04

(52) U.S. Cl. 361/93.8

(57) ABSTRACT

An inrush current preventing circuit includes a rectification circuit, a temperature-sensitive component, a controller, a switching circuit, and a tank circuit. The controller outputs a control signal to turn on the switching circuit in response to the tank circuit being at a substantially full voltage, and the rectification circuit and the switching circuit forming a current loop for providing power from the rectification circuit to an electronic device. The controller outputs no control signal to turn off the switching circuit in response to the tank circuit being undercharged, and the rectification circuit and temperature-sensitive component forming a current loop for providing power from the rectification circuit to the electronic device for protecting the electronic device.

### BACKGROUND

1. Field of the Invention

Embodiments of the present disclosure relate to preventive circuits, and more particularly to an inrush current preventing circuit.

2. Description of the Related Art

Inrush current refers to the maximum instantaneous input current drawn by an electrical device when first turned on. The electrical device may be damaged because of the inrush current which is far more than a maximum current the electrical device can accept.

Therefore, what is needed, is an inrush current preventing circuit which can solve the above problem.

### BRIEF DESCRIPTION OF THE DRAWINGS

FIG. 1 is a block diagram of one embodiment of an inrush current preventing circuit of the present disclosure.

FIG. 2 is one embodiment of a circuit diagram of FIG. 1.

### DETAILED DESCRIPTION

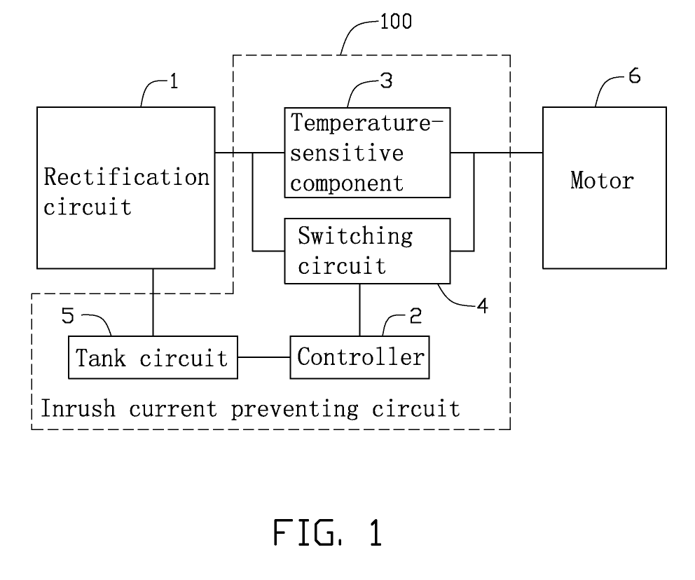

Referring to FIG. 1, one embodiment of an inrush current preventing circuit 100 is configured to protect an electronic device, such as a motor 6. The inrush current preventing circuit 100 is connected to a rectification circuit 1 and a controller 2. The inrush current preventing circuit 100 includes a temperature-sensitive component 3, a switching circuit 4, and a tank circuit 5. The temperature-sensitive component 3 is connected between the rectification circuit 1 and the motor 6. The switching circuit 4 is connected to the temperature-sensitive component 3 in parallel. The rectification circuit 1 is connected to the tank circuit 5 for charging the tank circuit 5. The controller 2 is connected between the switching circuit 4 and the tank circuit 5.

The rectification circuit 1 is configured to convert an alternating current (AC) voltage to a direct current (DC) voltage. The DC voltage is provided to the motor 6 via the temperature-sensitive component 3. When the temperature-sensitive component 3 initially starts operating, the temperature of the temperature-sensitive component 3 is low. As a result, according to the characteristic of the temperature-sensitive component 3, the resistance of the temperature-sensitive component 3 is high. Meanwhile, the DC voltage from the rectification circuit 1 charges to the tank circuit 5. When the tank circuit 5 is undercharged (e.g., less than the full voltage capacity of the tank circuit 5), the controller 2 outputs no signal to turn off the switching circuit 4. Therefore, little current flows through the temperature-sensitive component 3 to the motor 6, thereby preventing an excess amount of current from flowing to the motor 6. Thus, the temperature-sensitive component 3 limits the amount of current that can flow to the motor 6 so as to protect the motor 6 from damage.

When the tank circuit 5 is at full voltage, the controller 2 outputs a low level control signal to turn on the switching circuit 4. At this moment, the temperature-sensitive component 3 is short-circuited. The DC voltage is provided to the motor 6 via the switching circuit 4. For this reason, the temperature-sensitive component 3 stops operating, and does not generate much heat.

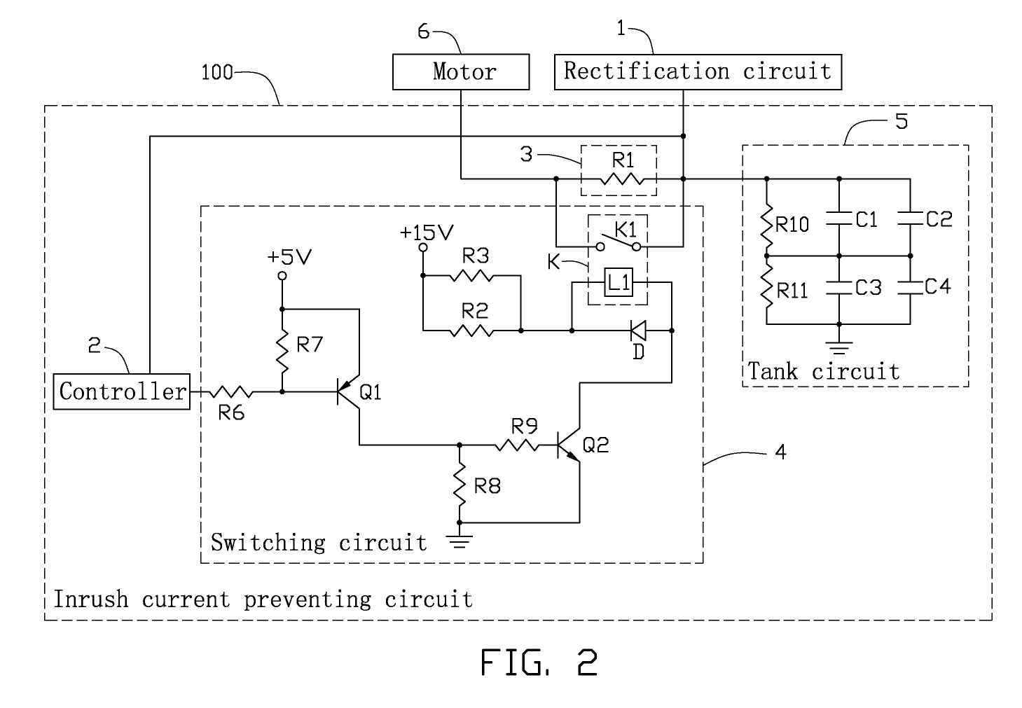

Referring to FIG. 2, the temperature-sensitive component 3 includes a negative temperature coefficient thermistor R1. The switching circuit 4 includes a relay K, a diode D, a first transistor Q1, a second transistor Q2, and six resistors R2, R3, R6-R9. The relay K includes a switch K1 and a coil L1. The tank circuit 5 includes four capacitors C1-C4, and two resistors R10-R11. In this current embodiment, the first transistor Q1 is a positive-negative-positive (PNP) type transistor, and the second transistor Q2 is a negative-positive-negative (NPN) type transistor.

A first end of the negative temperature coefficient thermistor R1 is connected to the rectification circuit 1, and a first end of the switch K1 of the relay K. A second end of the negative temperature coefficient thermistor R1 is connected to a second end of the switch K1, and configured for connecting to the motor 6. A first end of the coil L1 of the relay K is connected to the anode of the diode D. A second end of the coil L1 is connected to a 15V power source via the resistor R2, and the cathode of the diode D. The resistor R2 is connected to the resistor R3 in parallel. The base of the first transistor Q1 is connected to the controller 2 via the resistor R6 to receive the low level control signal. The base of the first transistor Q1 is also connected to a 5V power source via the resistor R7. The emitter of the first transistor Q1 is connected to the 5V power source. The collector of the first transistor Q1 is grounded via the resistor R8. The base of the second transistor Q2 is connected to the collector of the first transistor Q1 via the resistor R9. The emitter of the second transistor Q2 is grounded. The collector of the second transistor Q2 is connected to the anode of the diode D. It may be understood that the 15V power source and the 5V power source are exemplary voltages and may vary depending on the embodiment and the purpose of the an electronic device coupled to the inrush current preventing circuit 100.

A first end of the resistor R10 is connected to the first end of the resistor R1, a first end of the capacitor C1, and a first end of the capacitor C2. A second end of the resistor R10 is grounded via the resistor R11. A second end of the capacitor C1 is grounded via the capacitor C3. A second end of the capacitor C2 is grounded via the capacitors C4. The second end of the resistor R10 is also connected to the second ends of the capacitors C1 and C2. The first ends of the capacitors C1 and C2 are connected to the controller 2 for the controller 2 to output a low level signal correspondingly. A node between the resistors R10 and R11 is connected to a node between the capacitors C1 and C3, and a node between the capacitors C2 and C4.

When the motor 6 is first turned on, the temperature of the negative temperature coefficient thermistor R1 is low. As a result, the resistance of the negative temperature coefficient thermistor R1 is high. Meanwhile, the four capacitors C1-C4 are voltage charged. When the four capacitors C1-C4 are undercharged, the controller 2 outputs no signal, and the switching circuit 4 turns off. The rectification circuit 1 and the negative temperature coefficient thermistor R1 form a loop to provide power to the motor 6. Because of the high resistance of the negative temperature coefficient thermistor R1, little current flows to the motor 6, thereby preventing an excess amount of current from flowing to the motor 6 when the motor 6 is first turned on.

When the four capacitors C1-C4 are at full voltage, the controller 2 outputs a low level signal to the switching circuit 4. The first and second transistors Q1 and Q2 turn on. An electric potential of the first end of the coil L1 is about 0. Moreover, the 15V power source outputs a 12V voltage to the second end of the coil L1 via the resistors R2 and R3. A voltage difference between the first and second ends of the coil L1 is about 12 volts, the switch K1 turns on. The negative temperature coefficient thermistor R1 is short-circuited. The DC voltage is provided to the motor 6 via the relay K. For this reason, the negative temperature coefficient thermistor R1 stops operating, and does not generate much heat.

In the current embodiment, the diode D is configured for protecting the second transistor Q2. The resistors R2, R3, and R6-R11 are voltage dividers. In other embodiments, the tank circuit 5 may include more or less than four capacitors. The inrush current preventing circuit 100 is also configured for protecting other electronic devices.

The foregoing description of the various inventive embodiments of the disclosure has been presented only for the purposes of illustration and description and is not intended to be exhaustive or to limit the disclosure to the precise forms disclosed. Many modifications and variations are possible in light of the above teaching. The embodiments were chosen and described in order to explain the principles of the disclosure and their practical application so as to enable others of ordinary skill in the art to utilize the disclosure and various embodiments and with various modifications as are suited to the particular use contemplated. Alternately embodiments will become apparent to those of ordinary skill in the art to which the present disclosure pertains without departing from its spirit and scope. Accordingly, the scope of the present disclosure is defined by the appended claims rather than the foregoing description and the various inventive embodiments described therein.

What is claimed is:

1. An inrush current preventing circuit for protecting an electronic device from inrush current, the circuit comprising:
a rectification circuit for converting an alternating current (AC) voltage to a direct current (DC) voltage;
a temperature-sensitive component connected between the rectification circuit and the electronic device, wherein the temperature-sensitive component is configured for outputting the DC voltage from the rectification circuit to the electronic device, wherein the temperature-sensitive component has a high resistance value;
a switching circuit connected to the temperature-sensitive component in parallel, wherein the temperature-sensitive component is short-circuited in response to the switching circuit turning on;
a tank circuit connected to the rectification circuit, wherein the tank circuit is voltage charged by the rectification circuit; and
a controller connected between the switching circuit and the tank circuit, for controlling the switch circuit according to a voltage charge level of the tank circuit;
wherein the controller outputs a control signal to turn on the switching circuit in response to the tank circuit being at a substantially full voltage, the rectification circuit and the switching circuit forming a current loop to provide power from the rectification circuit to the electronic device;
wherein the controller does not output a control signal to turn off the switching circuit in response to the tank circuit being undercharged, the rectification circuit and temperature-sensitive component forming a current loop to provide power from the rectification circuit to the electronic device such that an excess amount of current is prevented from flowing to the electronic device.

2. The inrush current preventing circuit of claim 1, wherein the temperature-sensitive component is a negative temperature coefficient thermistor.

3. The inrush current preventing circuit of claim 1, wherein the switching circuit comprises a relay, a first transistor, and a second transistor, the relay comprises a switch and a coil, the switch is connected to the temperature-sensitive component; a base of the first transistor is connected to the controller, and a first power source via a resistor; an emitter of the first transistor is connected to the first power source; a collector of the first transistor is grounded via another resistor, and connected to a base of the second transistor; an emitter of the second transistor is grounded; a collector of the second transistor is connected to a first end of the coil; a second end of the coil is connected to a second power source.

4. The inrush current preventing circuit of claim 3, wherein the switching circuit further comprises a diode, an anode of the diode is connected to the first end of the coil, a cathode of the diode is connected to the second power source.

5. The inrush current preventing circuit of claim 3, wherein the first power source is a 5V direct current power source.

6. The inrush current preventing circuit of claim 3, wherein the second power source is a 15V direct current power source.

7. The inrush current preventing circuit of claim 3, wherein the first transistor is a positive-negative-positive type transistor, the second transistor is a negative-positive-negative type transistor.

8. The inrush current preventing circuit of claim 1, wherein the tank circuit comprises a capacitor, a first end of the capacitor is connected to the temperature-sensitive component and the controller, a second end of the capacitor is grounded.

9. The inrush current preventing circuit of claim 1, wherein the tank circuit comprises a first capacitor, a second capacitor, a first resistor, and a second resistor; a first end of the first resistor and a first end of the first capacitor are connected to the temperature-sensitive component, a second end of the first resistor is grounded via the second resistor, a second end of the first capacitor is grounded via the second capacitor; a node between the first and second resistors is connected to a node between the first and second capacitors.
